(19) United States
(12) Patent Application Publication
(10) Pub. No.: US 2008/0054021 A1
(43) Pub. Date: Mar. 6, 2008

(54) Scent dispenser

(76) Inventors: William Baxter Brown, Nebo, NC (US); Vincent Duff Wilson, Newland, NC (US)

Correspondence Address: William Baxter Brown Jr, 296 Green Briar Dr, Nebo, NC, 28761, US

(21) Appl. No.: 11/511,813

(22) Filed: Aug. 29, 2006

(51) Int. Cl. B67D 5/64

(52) U.S. Cl. 222/175

(57) ABSTRACT

The Sub Chapter S Corporation of WILSON-BROWN has designed the following invention to be primarily directed towards the hunting industry as a multipurpose deer lure dispenser.

“TRACK-N-TRAIL” is a bottle molded from high density polyethylene, with a threaded top opening (inlet) used for filling, a black flip top cap for sealing and dispensing, a molded clip used for attaching the bottle to various items, an additional molded opening at the bottom (outlet) used for dispensing the contents. Additionally, this opening is a barbed protrusion used to attach a vinyl hose/valve assembly to direct and regulate the flow of the bottle contents. A rubber band is used to assist in holding the hose and valve assembly in place while the hunter is walking.

The TRACK-N-TRAIL invention is designed to allow hunters the ability to fill the bottle with a substance of their choice and dispense it in one of two ways, through the inlet or the outlet.

### BACKGROUND OF THE INVENTION

The initial concept of this invention was motivated by the need to improve upon current scent products that inadequately dispense scent for deer hunting purposes. During time spent in the field using some of the products currently on the market, it was noted that there were many deficiencies in their design. As a result, the invention “TRACK-N-TRAIL” was developed to overcome these deficiencies. A product was needed that eliminated error, reduced foreign scent, had multiple uses, and would be reusable. In addition to these characteristics, the application of direct scent placement (applying the scent directly from the dispenser to the primary object) was developed due to its inherent superiority in regards to effectiveness when compared to indirect scent placement (applying scent to a secondary object that transfers it to the primary object). This technique also utilizes the “Hot Trail” technique where animals will follow the hottest or freshest scent.

The above reasons are why the invention “TRACK-N-TRAIL” was developed.

### BRIEF SUMMARY OF INVENTION

The invention “TRACK-N-TRAIL” is a multi-purpose product directed at the deer hunting market with specific focus on scent application and dispersal. This product is designed to allow the user the ability to fill it with their choice of scent and then dispense the contents in multiple ways.
A. Through the flip top cap for direct placement of its contents to a variety of specific areas, scent wicks, cotton balls, etc. to establish scent stations.
B. Through the bottom hollow barbed protrusion connected by a vinyl hose with an attached micro-flow control valve for maximum control of scent volume.

This is performed by clipping the unit to the hunters boot, opening the valve and walking in a specified direction there by establishing a controlled drip pattern for direct scent placement. This produces a realistic scent trail that is based upon the hot trail philosophy.
C. Another means of dispensing is attaching the unit by the clip on a limb and adjusting the micro-flow valve to 1 drip per second with the turret cap closed. The pressure in the unit will rise and fall with temperature forcing a predetermined amount of content out of the bottle. This stationary controlled flow method will establish and maintain an active scrape for days.

### DETAILED DESCRIPTION OF INVENTION

The Sub Chapter S Corporation of WILSON-BROWN is providing the following information as a detailed description of the invention, TRACK-N-TRAIL, filed for at the USPTO. This invention is primarily directed towards the hunting industry but is not limited to this market segment. The product outlined here and from this time forward, “TRACK-N-TRAIL”, is specifically focused on the deer lure, drip, and dispensing market.

The main component of TRACK-N-TRAIL is a black matte 4 plus ounce flat oval style bottle molded from high density polyethylene by injection blow molding. The over-all dimensions of the bottle are as follows; 132.3 mm in length by 62.8 mm in width by 30 mm in breadth with a 2 mm minimum wall thickness. As a customer benefit the bottle has increments of 1 ounce molded in the bottle for volume monitoring.

This one piece all inclusive bottle is specifically designed, and is unique to any bottle currently manufactured for the deer lure and scent industry.

There are three main elements incorporated into the WILSON-BROWN design that differentiate it from any other dispensing bottle in the field. The first element is a threaded top opening, (inlet), used for filling, dispensing, and cleaning that is 28 mm in diameter with a 410 thread specification. Attached to this opening is a standard 28/410 black flip top style cap for sealing, venting (necessary for proper fluid flow in some applications) and dispensing.

The second element to the TRACK-N-TRAIL design is a molded clip that is located on the back of the bottle. This clip is designed with no moving parts for quiet operation and will be used for attaching the bottle to belts, boots, tree limbs and various items while the unit is dispensing. Additionally, the clip has a hollow design to act as a reservoir for the contents in the bottle. The basic dimensions of the clip are as follows, 80 mm in length, by 28 mm in width with a thickness ranging from 12 mm to 7 mm.

Third, at the bottom of the bottle is a molded opening, (outlet), used for dispensing the contents of the bottle. This opening is a barbed protrusion that is 13 mm in length with an outside diameter of 4.80 mm with specific barb dimensions of 5 mm in length with a tapered head of 5.80 mm to 3.7 mm. It also has an inside diameter or opening of 2.7 mm. The barb acts as a connection point for a one-quarter inch diameter by 12 inch long matte black vinyl tube that slides firmly over the barbed protrusion until seated against the bottle for a leak proof seal. Installed on the end of the vinyl tube will be a black plastic ball type mirco-adjustable flow control valve. This valve is provided by a contracted supplier.

The final component of the TRACK-N-TRAIL unit is a 6 inch by one-half inch EPDM grade rubber band with a one-half inch pull tab. The band is weather resistant and used to stabilize the vinyl hose during dispensing while it is clipped on a hunting boot. This item is also purchased from a contracted supplier.

The TRACK-N-TRAIL invention is designed to allow hunters the ability to fill the bottle with a substance of their choice, and dispense it in one of two ways, through the black turret style cap (inlet), or through the outlet using the barbed protrusion and one-quarter inch black vinyl hose with the micro-adjustable flow control valve. Using these two methods gives the hunter three different uses, the first method is where the unit is used as an outlet dispenser to lay scent trails using the clip as a boot attachment. The scent trail is laid as scent is dispersed onto the ground while the hunter walks in a pre-determined manner. This is what is defined by WILSON-BROWN as direct scent placement, which doesn't rely on any secondary process or item in which scent is delivered to the ground. This method also provides a realistic scent trail that is based upon the trail getting hotter as it is made.

Second, by utilizing the clip to attach unit to a tree limb or branch in order to maintain a buck deer scrape for days with the proper setting of the black turret style cap and micro-adjustable flow control valve.

Third, as a top dispenser for setting up scent stations by applying scent directly to wicks, cotton balls, limbs, or other specific areas that one chooses. In conclusion the TRACK-N-TRAIL scent dispensing is a three in one device that provides hands free operation, easy set-up and efficient use. It is also light weight, self contained and reusable year after year.

### BRIEF DESCRIPTION OF DRAWINGS

The following information is a brief summary that describes three pages of drawings and the five views.

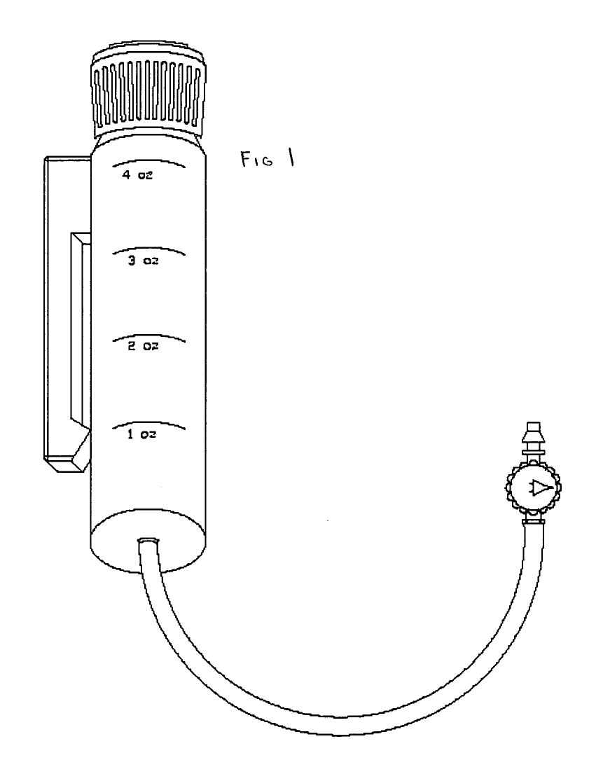

On page 1 FIG. 1 shows a complete outside view of the fully assembled invention. This comprises of the cap, the bottle with clip and one ounce indicators along with the vinyl hose and micro-adjustable valve.

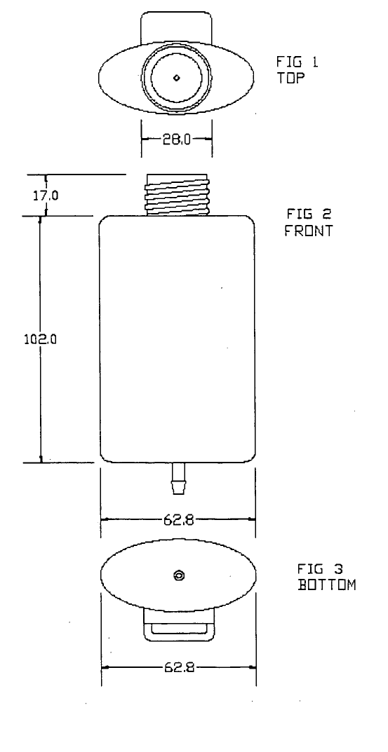

Page 2 has three views showing the bottle top, front and bottom. FIG. 1 displays the bottle top view of neck, clip and bottle, FIG. 2 displays the bottle front while also showing the bottle neck and barbed protrusion, figure three displays the bottle bottom and an end view of the clip.

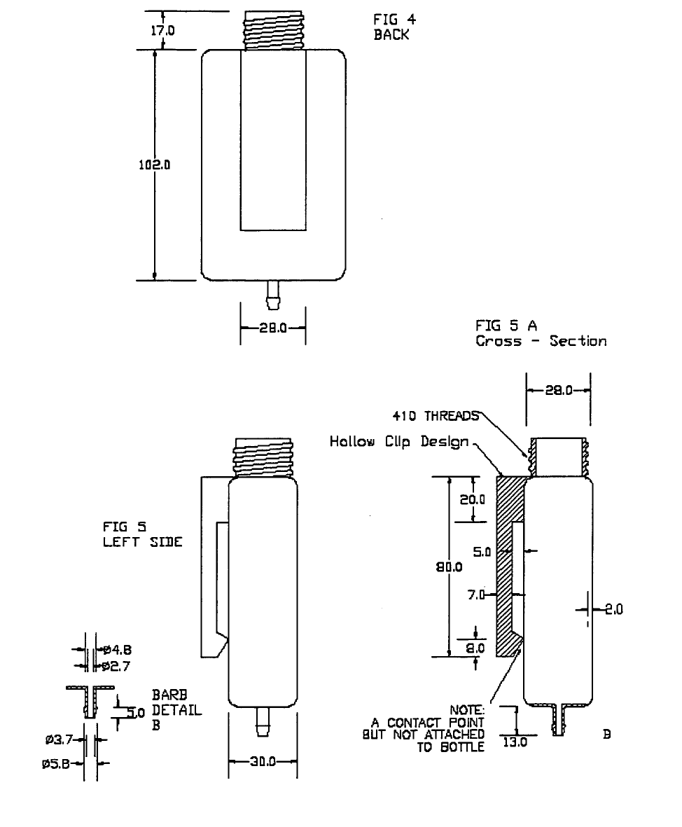

Page 3 has four views showing the many features of the bottle. Starting at the top of the page, FIG. 4 shows the bottle back displaying the clip, neck and barb. FIG. 5 displays the left side of the bottle giving a clear view of the neck, clip and barb. Detail B the BARB Detail shows a cross-section close up of the barb. FIG. 5A is a cross-section of the entire bottle covering dimensions on the bottle, neck, clip and barb.

### BRIEF STATEMENT

This brief statement is written to verify that the contents of this specification has not been added to or changed. Only the information as requested in the return letter has been added in order to make this document complete.

### DETAILED DESCRIPTION OF INVENTION

Limited Liability Corporation of WILSON-BROWN is providing the following information as a detailed description of the invention, TRACK-N-TRAIL, filed for at the USPTO. This invention is primarily directed towards the hunting industry but is not limited to this market segment. The product outlined here and from this time forward, “TRACK-N-TRAIL”, is specifically focused on the deer lure, drip, and dispensing market.

The main component of TRACK-N-TRAIL is a black matte 4 plus ounce flat oval style bottle molded from high density polyethylene by injection blow molding. The over-all dimensions of the bottle are as follows; 132.0 mm in length by 62.8 mm in width by 30 mm in breadth with a 2 mm minimum wall thickness. (See FIGS. 4, 5, and 5A on Page 3) As a customer benefit the bottle has a sight window (indicator strip) with increments of 1 ounce molded in the bottle for volume monitoring. (See FIG. 1 Page 1)

This one piece all inclusive bottle is specifically designed, and is unique to any bottle currently manufactured for the deer lure and scent industry. (See FIG. 1 Page 1)

There are three main elements incorporated into the WILSON-BROWN design that differentiate it from any other dispensing bottle in the field. The first element is a threaded top opening, (inlet), used for filling, dispensing, and cleaning that is 28 mm in diameter with a 410 thread specification. Attached to this opening is a standard 28/410 black turret style cap for sealing, venting (necessary for proper fluid flow in some applications) and dispensing. (See FIG. 1 Page 2)

The second element to the TRACK-N-TRAIL design is a molded clip that is located on the back of the bottle. This clip is designed with no moving parts for quiet operation and will be used for attaching the bottle to belts, boots, tree limbs and various items while the unit is dispensing. Additionally, the clip has a hollow design to act as a reservoir for the contents in the bottle. The basic dimensions of the clip are as follows, 80 mm in length, by 28 mm in width with a thickness ranging from 12 mm to 7 mm. (See FIG. 5A Page 3)

Third, at the bottom of the bottle is a molded opening, (outlet), used for dispensing the contents of the bottle. This opening is a barbed protrusion that is 13 mm in length with an outside diameter of 4.75 mm with specific barb dimensions of 5 mm in length with a tapered head of 5.75 mm to 3.7 mm. It also has an inside diameter or opening of 2.7 mm. The barb acts as a connection point for a one-quarter inch diameter by 12 inch long matte black vinyl tube that slides firmly over the barbed protrusion until seated against the bottle for a leak proof seal. Installed on the end of the vinyl tube will be a black plastic ball type micro-adjustable flow control valve. This valve is provided by a contracted supplier. (See FIG. 5 Barb Detail B Page 3)

The final component of the TRACK-N-TRAIL unit is a 6 inch by one-half inch EPDM grade rubber band with a one-half inch pull tab. The band is weather resistant and used to stabilize the vinyl hose during dispensing while it is clipped on a hunting boot. This item is also purchase from a contracted supplier.

The TRACK-N-TRAIL invention is designed to allow hunters the ability to fill the bottle with a substance of their choice, and dispense it in one of two ways, through the black turret style cap (inlet), or through the outlet using the barbed protrusion and one-quarter inch black vinyl hose with the micro-adjustable flow control valve. Using these two methods gives the hunter three different uses, the first as a top dispenser for setting up scent stations. This is done by applying scent directly to wicks cotton balls limbs or and specific area one chooses. The second method is where the unit is used as an outlet dispenser to lay scent trails using the clip as a boot attachment. The scent trail is laid as scent is dispersed onto the ground while the hunter walks in a pre-determined manner. This is what is defined by WILSON-BROWN as direct scent placement, which doesn't rely on any secondary process or item in which scent is delivered to the ground. This method also provides a realistic scent trail that is based upon the trail getting hotter as it is made. Thirdly, by utilizing the clip to attach unit to a tree limb or branch in order to maintain a buck deer scrape for days with the proper setting of the black turret style cap and micro-adjustable flow control valve. (See FIG. 1, Page 1)

In conclusion the TRACK-N-TRAIL scent dispensing is a three in one device that provides hands free operation, easy set-up and efficient use. It is also light weight, self contained and reusable year after year.

We claim that our invention is:

1. A plastic bottle of one piece molded construction of no particular size or shape, for the purpose of containing, dispensing, pulsing or exhausting liquids or solids through a unique one piece bottle design that utilizes direct scent placement.
(i) a mouth at the top with no specific shape or size through which liquids or solids may be filled and to which a variety of closures can be attached.

2. The bottle of claim 1:
Having an undefined hollow protrusion of no specific size, shape, or length, extending from the bottom through which no specific compound or liquid may be exhausted, released or dispensed in any manner.

3. The bottle of claim 1:
Having an undefined external configuration, of no specific design attached to any defined area for the affixing or mounting to a variety of objects.
